(19) United States
(12) Patent Application Publication
(10) Pub. No.: US 2026/0081426 A1
(43) Pub. Date: Mar. 19, 2026

(54) Electrical Power Distribution System with Electronically Commutated Motor and Generator for Efficient Accommodation of Starting and Running Loads

(71) Applicant: Lance Anthony Cook, Hearne, TX (US)

(72) Inventor: Lance Anthony Cook, Hearne, TX (US)

(21) Appl. No.: 19/329,480

(22) Filed: Sep. 15, 2025

Related U.S. Application Data
(60) Provisional application No. 63/694,738, filed on Sep. 13, 2024.

(51) Int. Cl. H02J 3/28; H02K 7/116; H02K 7/20; H02P 6/15; H02P 9/02

(52) U.S. Cl. CPC H02J 3/28; H02K 7/116; H02K 7/20; H02P 6/15; H02P 9/02; H02J 2101/24; H02J 2105/12

(57) ABSTRACT

An electrical power distribution system and method are provided for efficiently accommodating disparities between starting and running loads without requiring an oversized primary power source. The system comprises a battery configured to provide a power supply, an electronically commutated motor (ECM) driven by the battery, a transmission gearbox mechanically coupled to the ECM to increase its rotational speed, an electronically commutated generator (ECG) driven by the gearbox to generate an output current, a charging circuit to recharge the battery with the ECG output, and an output to provide the ECG current to a load. The ECM includes a first coil stator and a first permanent magnet rotor, while the ECG includes a second permanent magnet rotor driven by the gearbox and a second coil stator.

### BACKGROUND OF THE INVENTION

### Field of Invention

The various aspects discussed herein relate to electrical power distribution systems.

### Description of Related Art

Conventional electrical power distribution systems are used to provide power to various loads from a power source such as a battery. However, there are problems with existing power distribution approaches. Many electrical loads have significantly higher starting power requirements compared to their steady-state running power needs. Batteries and other power sources sized for the running load may not be able to handle the much higher starting loads. This can necessitate oversizing the power source just to accommodate transient starting needs, increasing system size, weight and cost.

Fuel-based generators with batteries for excitation have been used to handle variable loads in some applications. However, generators have their own disadvantages such as noise, emissions, maintenance needs and reliance on fuel supplies.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present invention provides an electrical power distribution system and method that efficiently accommodates disparities between starting and running loads without requiring an oversized primary power source. In one aspect, the system comprises a battery configured to provide a power supply, an electronically commutated motor (ECM) driven by the battery, a transmission gearbox mechanically coupled to the ECM to increase its rotational speed, an electronically commutated generator (ECG) driven by the gearbox to generate an output current, a charging circuit to recharge the battery with the ECG output, and an output to provide the ECG current to a load.

The ECM includes a first coil stator to generate an electromagnetic field from the battery power and a first permanent magnet rotor that rotates in response to the field. The ECG includes a second permanent magnet rotor driven by the gearbox and a second coil stator that generates output current from the rotor's rotation.

In one embodiment, the system further includes a solar panel to charge the battery. The ECM and ECG are configured to provide utility-level power to a building independently of the grid. The output can provide starting current to an electric vehicle motor. The gearbox preferably provides a 3:1 to 10:1 ratio using a planetary gear system. The charging circuit maintains a constant voltage, while a controller monitors battery charge, controls ECM output, and regulates ECG output to the load.

In another embodiment, the system leverages the ECM's high starting torque and the ECG's efficient power generation, with the gearbox allowing a smaller ECM to drive a larger ECG at higher speeds. This provides an elegant solution to handle high starting loads without oversizing the battery, reducing system size, weight and cost compared to conventional approaches. I some embodiments multiple generators can be added to the gear.

The invention also provides a method comprising energizing the ECM stator to rotate its rotor, mechanically coupling the rotor to the gearbox to increase its speed, coupling the gearbox to the ECG rotor to induce output current in its stator, charging the battery with the output current, and providing the output current to a load.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a block diagram illustrating an electrical power distribution system according to an embodiment.

FIG. 2 is a flow diagram illustrating a method for operating the electrical power distribution system of FIG. 1.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

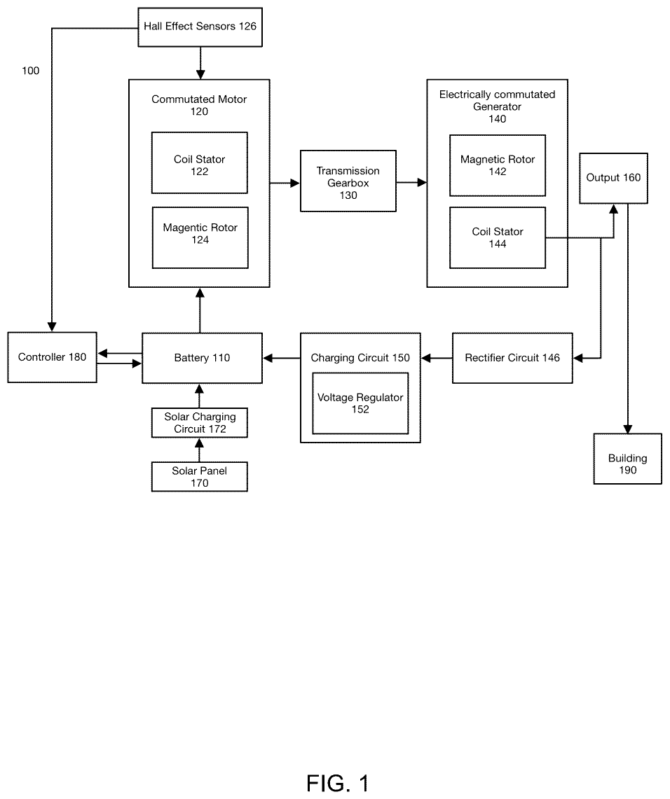

FIG. 1 is a block diagram illustrating an electrical power distribution system 100 according to an embodiment. In one embodiment, the system 100 includes a battery 110 configured to provide a power supply to the system. The battery 110 is electrically coupled to an electronically commutated motor 120.

The electronically commutated motor 120 comprises a first coil stator 122 coupled to the battery 110. In one embodiment, the first coil stator 122 is configured to generate an electromagnetic field when energized by the battery 110. The electronically commutated motor 120 further comprises a first permanent magnet rotor 124 configured to rotate in response to the electromagnetic field generated by the first coil stator 122. A plurality of Hall effect sensors 126 are disposed in the electronically commutated motor 120 and are configured to detect a position of the first permanent magnet rotor 124, thereby enabling control of commutation timing.

In one embodiment, the first permanent magnet rotor 124 is mechanically coupled to a transmission gearbox 130. The transmission gearbox 130 comprises a plurality of gears configured to increase a rotational speed of the first permanent magnet rotor 124. In some embodiments, the transmission gearbox 130 comprises a planetary gear system that provides a gear ratio between about 3:1 and about 10:1, by way of example and not limitation.

The transmission gearbox 130 is mechanically coupled to an electronically commutated generator 140. In one embodiment, the electronically commutated generator 140 comprises a second permanent magnet rotor 142 that is mechanically coupled to the transmission gearbox 130. The second permanent magnet rotor 142 is configured to be rotated by the transmission gearbox 130. The electronically commutated generator 140 further comprises a second coil stator 144 that is configured to generate an output current when the second permanent magnet rotor 142 is rotated.

In one embodiment, a rectifier circuit 146 is electrically coupled to the second coil stator 144. The rectifier circuit 146 is configured to convert AC output current from the second coil stator 144 to DC current.

According to an embodiment, a charging circuit 150 is coupled between the rectifier circuit 146 and the battery 110. The charging circuit 150 is configured to charge the battery 110 using the DC current from the rectifier circuit 146. In one embodiment, the charging circuit 150 comprises a voltage regulator 152 configured to maintain a substantially constant charging voltage applied to the battery 110.

In one embodiment, the system 100 further comprises an output 160 coupled to the second coil stator 144. The output 160 is configured to provide the output current generated by the second coil stator 144 to a load. In another embodiment, the output 160 is configured to provide a starting load current to an electric vehicle motor. The starting load current may be in the range of about 100 A to about 500 A, which may be sufficient to start an electric motor of a vehicle such as, by way of example and not limitation, a car, truck, or bus.

In some embodiments, a solar panel 170 is electrically connected to the battery 110 via a solar charging circuit 172. The solar panel 170 is configured to generate a charging current when exposed to solar radiation, and the solar charging circuit 172 is configured to control the charging current to charge the battery 110. This solar charging may supplement the charging provided by the electronically commutated generator 140, thereby enabling the system 100 to generate and store electrical power from both mechanical rotation and solar energy.

According to an embodiment, a controller 180 is communicatively coupled to the battery 110, the electronically commutated motor 120, the electronically commutated generator 140, and the output 160. The controller 180 is configured to monitor a state of charge of the battery 110 and control a power output of the electronically commutated motor 120 based on the monitored state of charge. For example, the controller 180 may increase the power output of the motor 120 when the state of charge falls below a threshold, thereby increasing power generation and charging of the battery 110. The controller 180 is further configured to regulate the output current provided to the load by the output 160 based on a load requirement. The regulation may involve adjusting the output voltage or current limit based on a required power level of the load.

In one embodiment, the electronically commutated motor 120 and electronically commutated generator 140 are configured to provide utility-level power supply to a building 190 independently of the power grid. The output 160 may be coupled to the building's electrical system through an inverter and transformer to provide AC power at the appropriate voltage and frequency. The system 100 may be sized to provide a continuous power output sufficient to meet the building's electrical load, such as, by way of example and not limitation, between about 10 kW and about 100 kW or more. By generating and storing its own power, the system 100 can operate as a self-sufficient microgrid for the building 190, thereby providing a reliable power supply even during grid outages.

In operation, the battery 110 energizes the first coil stator 122 of the electronically commutated motor 120, thereby generating an electromagnetic field. The first permanent magnet rotor 124 rotates in response to this electromagnetic field, with the Hall effect sensors 126 provide signals to control the commutation timing. The rotation of the first permanent magnetic rotor 124 is mechanically coupled to the transmission gearbox 130, which increases the rotational speed using its plurality of gears, wherein said gears may be configured in various arrangements to achieve the desired speed increase.

In one embodiment, the transmission gearbox 130 is configured to mechanically couple the increased rotational speed to the second permanent magnet rotor 142 of the electronically commutated generator 140, thereby causing it to rotate. This rotation of the second permanent magnet rotor 142 induces an AC output current in the second coil stator 144.

According to an embodiment, the AC output current from the second coil stator 144 is converted to DC current by the rectifier circuit 146. This DC current is then used by the charging circuit 150 to charge the battery 110, wherein the voltage regulator 152 maintains a substantially constant charging voltage.

In some embodiments, the DC output current from the second coil stator 144 is also provided via the output 160 to a load, such as providing a starting current to an electric vehicle motor.

Throughout operation, the solar panel 170 generally generates additional charging current when exposed to sunlight, which may be conditioned by the solar charging circuit 172 to charge the battery 110. This supplemental charging from the solar panel 170 is coupled to the charging from the generator 140.

In another embodiment, the controller 180 is configured to monitor the state of charge of the battery 110 and control the power output of the electronically commutated motor 120 accordingly, thereby regulating the charging. It also regulates the output current to the load based on the load requirements, adjusting output characteristics as needed.

In the microgrid embodiment, the system 100 provides a standalone power supply for the building 190, with the output inverter and transformer providing grid-level AC power derived from the mechanically-driven generator 140 and the energy stored in battery 110.

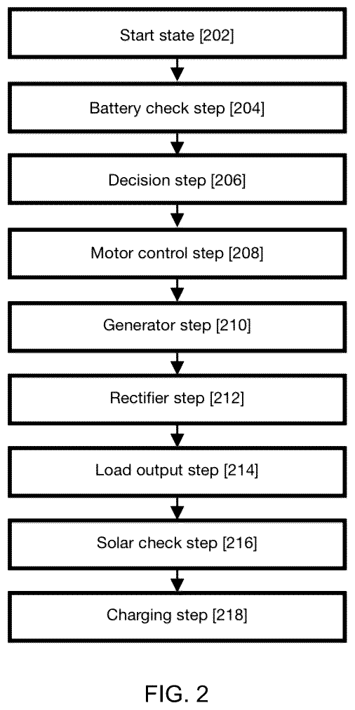

FIG. 2 is a flow diagram illustrating a method 200 for operating the electrical power distribution system 100 of FIG. 1. In one embodiment, the flow diagram comprises a series of steps represented by rectangles and a decision step represented by a diamond, wherein said steps are coupled to each other via unidirectional arrows indicating the sequence of operations.

In some embodiments, the method 200 begins at a start state 202. From the start state 202, the flow may proceed to a battery check step 204. At the battery check step 204, the controller 180 is configured to monitor a state of charge of the battery 110.

From the battery check step 204, the flow optionally proceeds to a decision step 206. At the decision step 206, the controller 180 can determine whether the state of charge is below a predetermined threshold. In one embodiment, if the state of charge is below the threshold, the flow proceeds to a motor control step 208. Alternatively, if the state of charge is not below the threshold, the flow might proceed to a load output step 214.

In another embodiment, at the motor control step 208, the controller 180 is configured to increase a power output of the electronically commutated motor 120, thereby increasing the rotational speed of the first permanent magnet rotor 124. The flow then typically proceeds to a generator step 210.

At the generator step 210, the increased rotational speed from the motor control step 208 is generally transferred via the transmission gearbox 130 to the second permanent magnet rotor 142, causing it to rotate and induce an AC output current in the second coil stator 144, wherein said second coil stator is disposed proximate to the second permanent magnet rotor. The flow then often proceeds to a rectifier step 212.

In some cases, at the rectifier step 212, the rectifier circuit 146 is configured to convert the AC output current from the generator step 210 into a DC current. The flow then proceeds to a charging step 218.

Returning to the decision step 206, if the state of charge is not below the threshold, the flow may proceed to the load output step 214. At the load output step 214, the controller 180 can allow the DC current from the second coil stator 144 to be provided via the output 160 to a load, wherein said load is coupled to the output. In one embodiment, the controller 180 is configured to regulate the voltage and current of the output 160 based on the load requirements. From the load output step 214, the flow typically proceeds to a solar check step 216.

At the solar check step 216, the solar panel 170, when exposed to sufficient solar radiation, is configured to generate a solar charging current that is conditioned by the solar charging circuit 172, wherein said solar charging circuit is coupled to the solar panel. The flow then generally proceeds to the charging step 218.

In some embodiments, at the charging step 218, the DC current from either or both of the rectifier step 212 and the solar check step 216 is used by the charging circuit 150 to charge the battery 110. In another embodiment, the voltage regulator 152, which is coupled to the charging circuit, is configured to maintain a substantially constant charging voltage during this step. From the charging step 218, the flow optionally returns to the battery check step 204, thereby forming a continuous loop.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. An electrical power distribution system comprising:
a) a battery configured to provide a power supply;
b) an electronically commutated motor comprising:
i. a first coil stator connected to the battery and configured to generate an electromagnetic field when energized by the battery, and
ii. a first permanent magnet rotor configured to rotate in response to the electromagnetic field generated by the first coil stator;
c) a transmission gearbox mechanically coupled to the first permanent magnet rotor, the transmission gearbox comprising a plurality of gears configured to increase a rotational speed of the first permanent magnet rotor;
d) an electronically commutated generator comprising:
i. a second permanent magnet rotor mechanically coupled to the transmission gearbox and configured to be rotated by the transmission gearbox, and
ii. a second coil stator configured to generate an output current when the second permanent magnet rotor is rotated;
e) a charging circuit connected between the second coil stator and the battery, the charging circuit configured to charge the battery using the output current from the second coil stator; and
f) an output connected to the second coil stator and configured to provide the output current to a load.

2. The electrical power distribution system of claim 1, further comprising a solar panel electrically connected to the battery and configured to charge the battery.

3. The electrical power distribution system of claim 1, wherein the electronically commutated motor and the electronically commutated generator are configured to provide utility-level power supply to a building independently of a power grid.

4. The electrical power distribution system of claim 1, wherein the output is configured to provide a starting load current to an electric vehicle motor.

5. The electrical power distribution system of claim 1, wherein the transmission gearbox comprises a planetary gear system.

6. The electrical power distribution system of claim 5, wherein the planetary gear system is configured to provide a gear ratio in the range of 3:1 to 10:1.

7. The electrical power distribution system of claim 1, wherein the charging circuit comprises a voltage regulator configured to maintain a constant charging voltage applied to the battery.

8. The electrical power distribution system of claim 1, wherein the electronically commutated motor further comprises a plurality of Hall effect sensors configured to detect a position of the first permanent magnet rotor for controlling commutation timing.

9. The electrical power distribution system of claim 1, wherein the electronically commutated generator further comprises a rectifier circuit configured to convert AC output current from the second coil stator to DC current for charging the battery.

10. The electrical power distribution system of claim 1, further comprising a controller configured to:
a) monitor a state of charge of the battery,
b) control a power output of the electronically commutated motor based on the state of charge, and
c) regulate the output current provided to the load based on a load requirement.

11. A method for distributing electrical power comprising:
a) energizing, using a battery, a first coil stator of an electronically commutated motor to generate an electromagnetic field;
b) rotating a first permanent magnet rotor of the electronically commutated motor in response to the generated electromagnetic field;
c) mechanically coupling the first permanent magnet rotor to a transmission gearbox;
d) increasing, using a plurality of gears in the transmission gearbox, a rotational speed of the first permanent magnet rotor;
e) mechanically coupling the transmission gearbox to a second permanent magnet rotor of an electronically commutated generator;
f) rotating, using the transmission gearbox, the second permanent magnet rotor;
g) inducing, by the rotation of the second permanent magnet rotor, an output current in a second coil stator of the electronically commutated generator;
h) charging, using a charging circuit connected between the second coil stator and the battery, the battery with the output current from the second coil stator; and
i) providing, via an output connected to the second coil stator, the output current to a load.

12. The method of claim 11, wherein charging the battery comprises maintaining, using a voltage regulator in the charging circuit, a constant charging voltage applied to the battery.

13. The method of claim 11, wherein the electronically commutated motor and the electronically commutated generator are configured to provide utility-level power supply to a building independently of a power grid.

14. The method of claim 11, further comprising detecting, using a plurality of Hall effect sensors in the electronically commutated motor, a position of the first permanent magnet rotor for controlling commutation timing.

15. The method of claim 11, further comprising converting, using a rectifier circuit in the electronically commutated generator, AC output current from the second coil stator to DC current for charging the battery.

16. The method of claim 11, further comprising:
a) monitoring, using a controller, a state of charge of the battery;
b) controlling, using the controller, a power output of the electronically commutated motor based on the state of charge; and
c) regulating, using the controller, the output current provided to the load based on a load requirement.

17. The method of claim 11, wherein providing the output current to the load comprises providing a starting load current to an electric vehicle motor.

18. The method of claim 11, further comprising charging the battery using a solar panel electrically connected to the battery.

19. The method of claim 11, wherein the transmission gearbox comprises a planetary gear system.

20. The method of claim 19, wherein the planetary gear system is configured to provide a gear ratio in the range of 3:1 to 10:1.
